(19) United States
(12) Patent Application Publication
(10) Pub. No.: US 2020/0320636 A1
(43) Pub. Date: Oct. 8, 2020

(54) SYSTEM AND METHOD FOR AUTOMATIC ANALYSIS AND MANAGEMENT OF A WORKERS COMPENSATION CLAIM

(71) Applicants: Albert Navarra, Newport Beach, CA (US); Ambika Sapra, Newport Beacgh, CA (US)

(72) Inventors: Albert Navarra, Newport Beach, CA (US); Ambika Sapra, Newport Beacgh, CA (US)

(21) Appl. No.: 16/372,739

(22) Filed: Apr. 2, 2019

(51) Int. Cl. G06Q 40/08; G06N 5/04; G06F 17/27; G06Q 10/10; G06F 16/93

(52) U.S. Cl. CPC G06Q 40/08; G06N 5/04; G06F 16/93; G06Q 10/10; G06F 17/279; G06F 17/2715

(57) ABSTRACT

A system and method for automatically analyzing information related to a workers' compensation claim and for providing a corresponding case analysis report. A licensed user computer is programmed to upload via a computer network documents and data related to a workers' compensation claim and then to receive a downloaded case analysis report comprising analysis and a recommended plan of action regarding the workers' compensation claim. A server computer is programmed to receive the documents and data related to the workers' compensation claim. The server computer includes programming for a pdf/image text extractor, a checklist data provider, an information identifier, a natural language processor, an issue identifier, an issue analyzer, and a decision data model. The server computer is programmed to generate the case analysis report and to download the report to the licensed user computer.

The present invention relates to systems and methods for managing insurance claims, and in particular, to systems and methods for managing workers' compensation claims.

### BACKGROUND OF THE INVENTION

### Workers' Compensation Insurance

Workers' Compensation is a form of insurance providing wage replacement and medical benefits to employees injured in the course of employment in exchange for mandatory relinquishment of the employee's right to sue his or her employer for the tort of negligence. When there has been an injury on the job and when a claim has been filed, a successful workers' compensation defense strategy is often very expensive for insurance companies and self-insured employers. There can be many documents to sort through and many deadlines to track. Legal issues also need to be considered. Appropriate actions need to be taken.

What is needed is a device and method that makes it easier and less expensive to conduct a successful workers' compensation defense.

### SUMMARY OF THE INVENTION

The present invention provides a system and method for automatically analyzing information related to a workers' compensation claim and for providing a corresponding case analysis report. A licensed user computer is programmed to upload via a computer network documents and data related to a workers' compensation claim and then to receive a downloaded case analysis report comprising analysis and a recommended plan of action regarding the workers' compensation claim. A server computer is programmed to receive the documents and data related to the workers' compensation claim. The server computer includes programming for a pdf/image text extractor, a checklist data provider, an information identifier, a natural language processor, an issue identifier, an issue analyzer, and a decision data model. The server computer is programmed to generate the case analysis report and to download the report to the licensed user computer.

### BRIEF DESCRIPTION OF THE DRAWINGS

FIG. 1 shows computer connectivity of a preferred embodiment of the present invention.

FIGS. 2-8 show a flowchart depicting a preferred embodiment of the present invention.

### DETAILED DESCRIPTION OF THE PREFERRED EMBODIMENTS

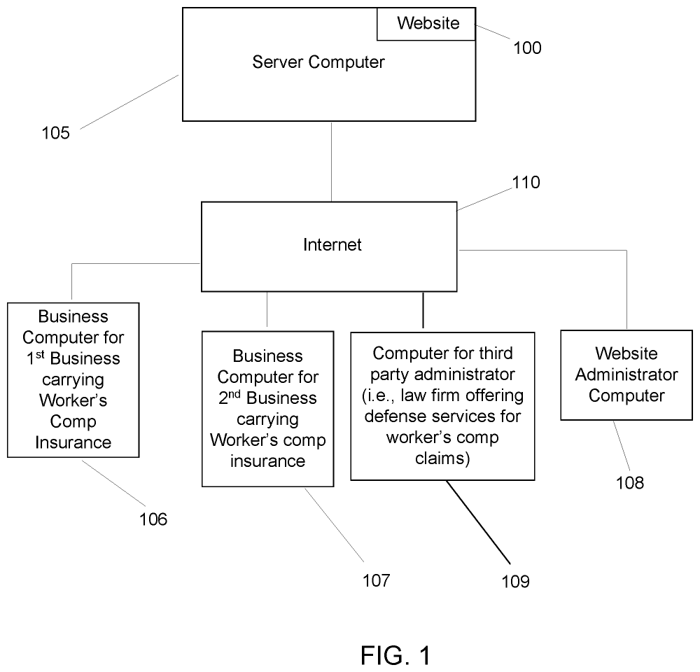

FIG. 1 shows a preferred embodiment of the present invention. The present invention allows for automated, simplified tracking and analysis of the facts and issues associated with a workers' compensation claim. In a preferred embodiment, a licensed user purchases access to software that allows the licensed user to track an ongoing or potential workers' compensation claim. Licensed user's may be a business that carries workers' compensation insurance. Or a licensed user may be a third-party administrator that monitors various workers' compensation claims. An example of a third-party administrator may be a law firm that specializes in workers' compensation defense. The system shown in FIG. 1 allows for licensed user to track, analyze and take appropriate action on workers' compensation claims as they occur.

FIG. 1 shows an example of a preferred embodiment of the present invention. An employer carrying workers' compensation insurance has purchased an account allowing the business to use business computer 106 to access website 100 via the Internet. Business computer 106 may be a personal computing device such as a laptop computer, a cell phone, and iPhone® or an iPad®. Access to website 100 allows the insurance carrier to analyze and process potential workers' compensation claims and active workers' compensation claims as they may occur. Likewise, a second business utilizes business computer 107 for the same purpose. In a similar fashion, a law firm specializing in workers' compensation defense utilizes computer 109 to access website 100 via the Internet for the same purpose.

An administrator for website 100 monitors all connectivity via website administrator computer 108.

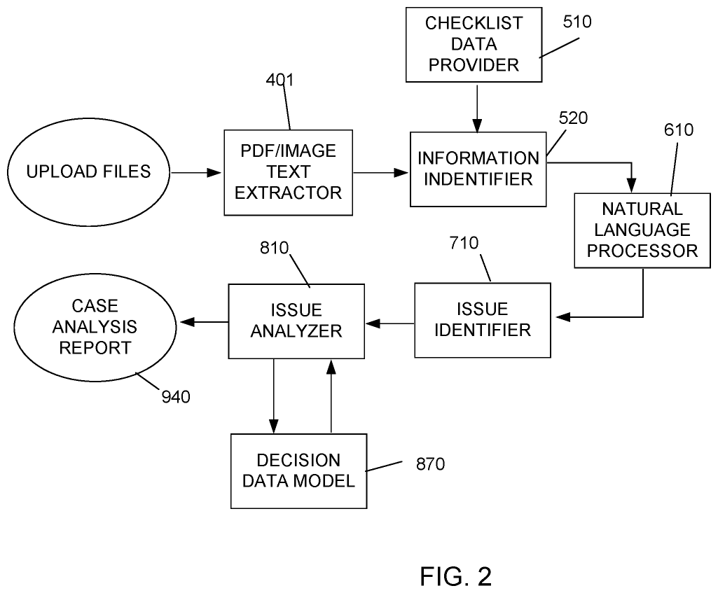

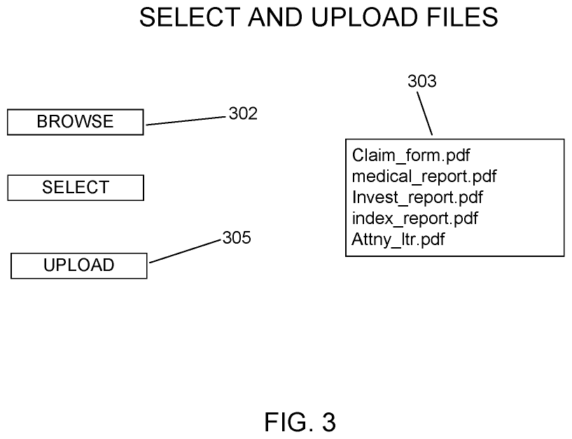

In a preferred embodiment of the present invention, website 100 is loaded onto server computer 105. Website 100 includes programming outlined by the flowchart depicted in FIG. 2 and described in greater detail in FIGS. 3-8.

In FIG. 3, the user has utilized computer 106 to log onto website 100 via the Internet. The user has clicked button 302 to browse the database on computer 106 (FIG. 2). The user has then selected files important to an ongoing workers' compensation claim. These files are displayed in display box 303 and include pdf files of the claim form, the medical report, the investigative report, the index report and the letter from opposing attorney who filed the claim. Once the claims are selected, they can be uploaded by clicking button 305.

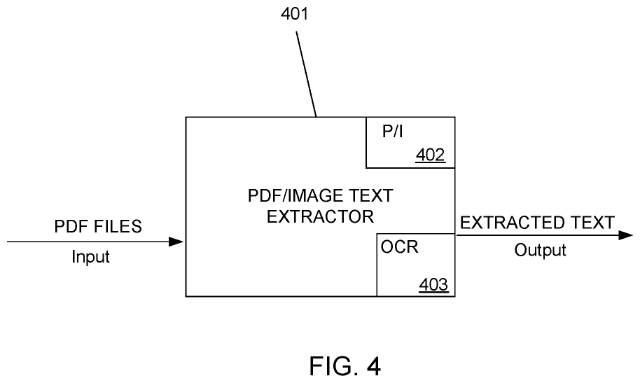

As shown in FIG. 2, after the pdf files have been uploaded to website 100, they will be modified via a pdf text extractor module 401 (FIG. 4). PDF text extractor 401 (FIG. 4) includes two parts. The first part is PDF to image converter 402. Converter 402 converts all the pages in the uploaded pdf files are converted to individual image files. Optical character recognition (OCR) tool 403 is then utilized to extract text from the individual image files.

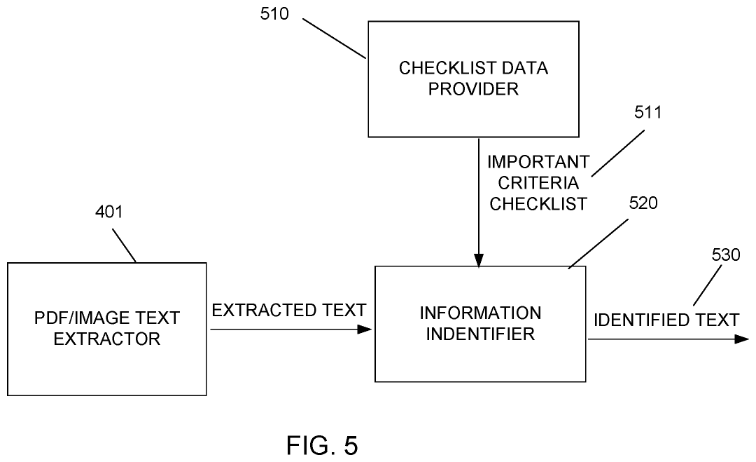

Extracted text is output from pdf text extractor 401 (FIG. 4) and is input into information identifier 520 (FIG. 5). Additionally, checklist data provider 510 inputs important workers' compensation claim criteria checklist 511 into information identifier 520. In a preferred embodiment, workers' compensation claim checklist 511 includes information that is important to the analysis of a workers' compensation claim. An item from checklist 511 is picked and its corresponding information is identified from the extracted text. Information identifier 520 identifies all possible information related to checklist 511 and presents as an output identified text 530.

For example, in one preferred embodiment “Date Claim Filed” is a checklist item included in checklist 511 to be identified from the extracted text. Information identifier 520 identifies all the possible information from the extracted text related to the claim date. Output leaving information identifier 520 is identified as identified text 530, which includes all the possible dates which could be the claim date.

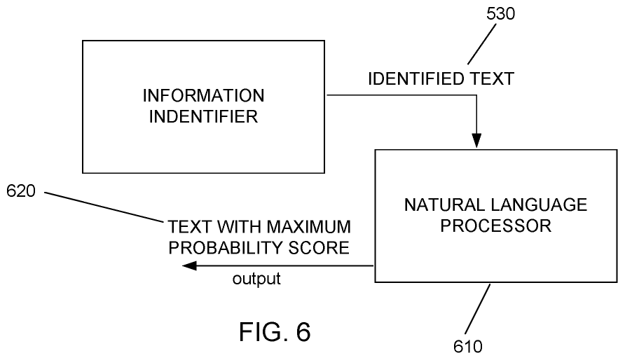

Identified text 530 is output from information identifier 520 and is input into natural language processor 610 (FIG. 6). Natural language processor includes programming to analyze identified text 530 and gives a probability score to each identified text. The identified text with the maximum probability score will be chosen as the required information.

For example, the date that has the maximum probability score will be chosen as the ‘claim date’ in the workers' compensation claim and this date will be used for further analysis. The text with the maximum probability score 620 is output from natural language processor 610.

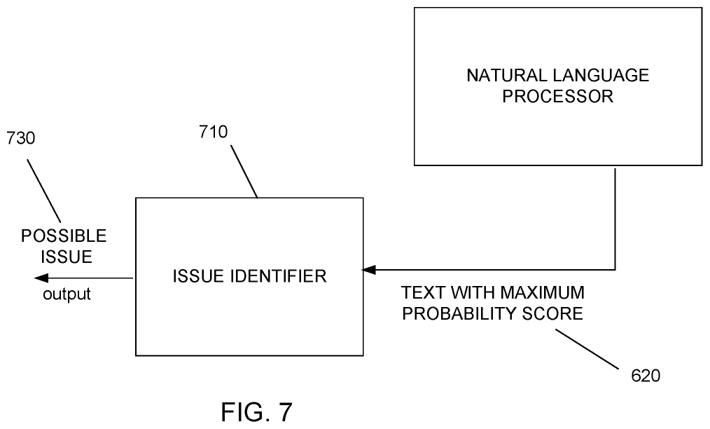

In FIG. 7, the text with maximum probability score 620 is input into issue identifier 710. Issue identifier 710 includes programming that checks the maximum probability score 620 with checklist 511 (FIG. 5) to identify issues that the input text 620 could be linked to. The output from issue identifier 710 is possible issue 730.

For example, in a preferred embodiment issue identifier receives input text 620 that is ‘claim date’. After checking ‘claim date’ input text 620 with checklist 511, issue identifier identifies a possible issue as ‘90-day decision deadline’, which is a deadline that is triggered as a result of reporting an injury for a potential workers' compensation claim.

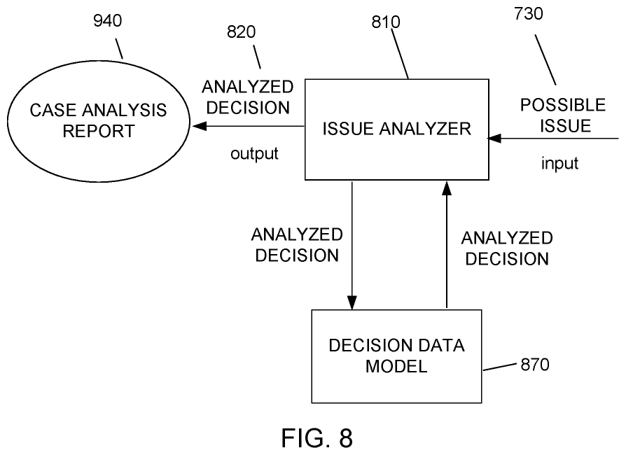

In FIG. 8, possible issue 730 is input into issue analyzer 810. Issue analyzer 810 includes programming that will analyze possible issue 730 utilizing parameters stored in checklist 511 (FIG. 5) and arrive at a decision. Analyzed decision 840 is output to decision data model 870 and to case analysis report 940.

For example, in a preferred embodiment issue analyzer 810 analyzes the issue of ‘90-day decision deadline with the following parameters established in checklist 511:
1. “Is the current date less than or more than 60 days from when the claim was filed?”
2. “Is the current date less than or more than 90 days from when the claim was filed?”

If the current date is less than 60 days from when the claim was filed, issue analyzer 810 includes programming to accept the checklist item and output analysis decision 840 that accepts the checklist item and issue a warning that alerts the user to the approaching 90-day deadline.

If the claim was filed 90 days after the date of injury (DOI) the checklist item will be rejected. The decision with evidence will be shown on case analysis report 940. Issue analyzer 810 then checks for other checklist items to gather more evidence for a detailed report.

If the claim was filed 90 days before the DOI the checklist item will be accepted. The decision with evidence will be shown on case analysis report 940. Issue analyzer 810 then checks for other checklist items to gather more evidence for a detailed report.

Also in FIG. 8, analyzed decision 840 is input to decision data model 870. Decision data model 870 will store analyzed decision 840 with evidence for the respective checklist item. The decision will be stored for future purposes.

For example, the decision with respect to the claim date will be stored for future purposes. Accordingly, issue analyzer 810 could potentially skip steps in its analysis after directly retrieving information from past analysis from decision data model 870 with regards to claim date. Machine learning programming is included in decision data model 870 allowing for issue analyzer 810 to continuously improve efficiency with the number of claim documents it reads and analyzes.

After completed, analyzed decision 840 is downloaded to the user's computer to form case analysis report 940. Case analysis report 940 includes the information about all items in checklist 511. Report 940 includes the following for all items in checklist 511:
1. Decision (whether accepted or rejected)
2. Detailed evidence (reason for acceptance or rejection)

For example, the first item checklist 511 (Date Claim filed) is the first item on case analysis report 940. The decision and its evidence is shown:
1. If the claim was filed 90 days after the date of injury (DOI) the checklist item will be rejected. The decision with evidence will be shown on case analysis report 940. The evidence is the Date of the Claim and the Date of the Injury.
2. If the claim was filed 90 days before the date of injury (DOI) the checklist item will be accepted. The decision with evidence will be shown on case analysis report 940. The evidence is the Date of the Claim and the Date of the Injury.

The device and method depicted in FIGS. 1-8 provides a tremendous benefit to licensed users. After comparison to criteria from checklist 511, data is extracted from the files uploaded by the licensed user. The data is analyzed to identify legal issues, analyze the issues and recommend action plan through downloadable case analysis report 940.

Benefits of the above described method and device include:
1. Accurate factual assessment of the case. A human acting alone may miss information, or record information incorrectly. However, the above describe method and device is accurate to a very high degree relative to humans.
2. Thorough identification of legal issues and defenses. A human being may miss issues and have incomplete or inaccurate beliefs about the law and how it applies to cases. The program has a very high degree of thoroughness and accuracy compared to humans.
3. The program implements a highly successful and efficient litigation strategy. “Breaking the Habit”® is a federally registered trademark owned by Sapra & Navarra, LLP, and the mark refers to “legal services, namely, providing legal defense for employers and insurance companies in workers' compensation cases.” The “Breaking the Habit”® strategy reduces average total cost per case and average cycle time (length of time case is open) by 67% for seven straight years. These results have been confirmed by the leading actuarial company in the California. In a preferred embodiment, checklist 511 is compiled in accordance with criteria consistent with the “Breaking the Habit”® strategy. Analysis and recommended actions are therefore conducted and presented in a fashion that is consistent with the “Breaking the Habit”® strategy.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A system for automatically analyzing information related to a workers' compensation claim and for providing a case analysis report, said system comprising:
A. at least one licensed user computer, said licensed user computer programmed to:
a. upload via a computer network documents and data related to a workers' compensation claim,
b. download via said computer network said case analysis report comprising analysis and recommended plan of action regarding said workers' compensation claim
B. at least one server computer accessible via said computer network, said at least one server computer programmed to receive said documents and data related to a workers' compensation claim, said at least one server computer comprising programming for:
a. a pdf/image text extractor for receiving said uploaded documents and data from said licensed user computer
b. a checklist data provider for providing a criteria checklist to be compared against said documents and data,
c. an information identifier for comparing said checklist to said uploaded documents and data to generate identified text,
d. a natural language processor for receiving said identified text and generating text with maximum probability score,
e. an issue identifier for receiving said text with maximum probability score and for generating possible issues,
f. an issue analyzer for receiving said possible issues and for generating an analyzed decision and said case analysis report, and
g. a decision data model for receiving said analyzed decision and for storing said analyzed decision for future analysis.

2. The system as in claim 1, wherein said at least one licensed computer is a laptop computer.

3. The system as in claim 1, wherein said at least one licensed computer is a cell phone.

4. The system as in claim 1, wherein said at least on licensed computer is an iPad®.

5. The system as in claim 1, wherein said at least one licensed computer is owned by a business carrying workers' compensation insurance.

6. The system as in claim 1, wherein said at least one licensed computer is owned by third party administrator.

7. A method for automatically analyzing information related to a workers' compensation claim and for providing a case analysis report, said method comprising the steps of:
A. utilizing at least one licensed user computer to upload via a computer network documents and data related to a workers' compensation claim,
B. utilizing at least one server computer to receive said documents and data related to a workers' compensation claim, said at least one server computer comprising programming for:
a. a pdf/image text extractor for receiving said uploaded documents and data from said licensed user computer
b. a checklist data provider for providing a criteria checklist to be compared against said documents and data,
c. an information identifier for comparing said checklist to said uploaded documents and data to generate identified text,
d. a natural language processor for receiving said identified text and generating text with maximum probability score,
e. an issue identifier for receiving said text with maximum probability score and for generating possible issues,
f. an issue analyzer for receiving said possible issues and for generating an analyzed decision and said case analysis report, and
g. a decision data model for receiving said analyzed decision and for storing said analyzed decision for future analysis, and
C. utilizing said at least one licensed computer to download via said computer network said case analysis report comprising analysis and recommended plan of action regarding said workers' compensation claim.

8. The method as in claim 7, wherein said at least one licensed computer is a laptop computer.

9. The method as in claim 7, wherein said at least one licensed computer is a cell phone.

10. The method as in claim 7, wherein said at least on licensed computer is an iPad®.

11. The method as in claim 7, wherein said at least one licensed computer is owned by a business carrying workers' compensation insurance.

12. The method as in claim 7, wherein said at least one licensed computer is owned by third party administrator.
